(19) United States
(12) Patent Application Publication
(10) Pub. No.: US 2014/0354557 A1
(43) Pub. Date: Dec. 4, 2014

(54) TOUCH SELECTION SYSTEM AND METHOD FOR ON-SCREEN DISPLAYED MULTIPLE OBJECTS

(71) Applicant: Compal Information R&D(Nanjing) Co., Ltd, Jiangsu (CN)

(72) Inventor: Yi-Qin SHEN, Jiangsu (CN)

(73) Assignee: Compal Information R&D(Nanjing) Co., Ltd, Jiangsu (CN)

(21) Appl. No.: 14/013,042

(22) Filed: Aug. 29, 2013

(30) Foreign Application Priority Data
Jun. 3, 2013 (CN) 201310219428.0

(51) Int. Cl. G06F 3/0484; G06F 3/0488; G06F 3/041

(52) U.S. Cl. CPC G06F 3/04842; G06F 3/041; G06F 3/04883
USPC 345/173

(57) ABSTRACT

A touch selection system for on-screen displayed multiple objects includes a control interface, a control trace processing unit and a control options processing unit. The control interface is configured for controlling objects. The control trace processing unit is configured for determining whether a control signal appears on the control interface and recording a control moving trace formed by the control signal on the control interface. The control options processing unit is configured for calculating at least one closed area formed by the control moving trace in accordance with the control moving trace, wherein the control options processing unit is further configured for determining whether the objects are located within the least one closed area to select the objects, and displaying at least one corresponding control option in accordance with the selected objects. A touch selection method is also provided.

### RELATED APPLICATIONS

This application claims priority to China Application Serial Number 201310219428.0, filed Jun. 3, 2013, which is herein incorporated by reference.

### BACKGROUND

1. Field of Invention

The present invention relates to a touch system. More particularly, the present invention relates to a system and a method for performing touch selection on multiple objects.

2. Description of Related Art

On an electronic device with a touch panel, a user may click the functional objects or input the data to control the electronic device via the touch panel. User can perform different operations more intuitively through a touch control operation with a humanized graphical user interface (GUI). Therefore, more and more touch control consumer electronic products are developed.

In general, on the current touch control electronic device, when desiring to select several functional objects or files, a user has to select the objects or files one by one. However, this operation method is not efficient under the case of many functional objects or files to be selected.

Further, when a user performs the touch control operation by using his or her finger, it is likely to touch unwanted objects or files accidentally, and the user has to select the objects or files again, thus wasting operation time.

Therefore, a heretofore unaddressed need exists in the art to address the aforementioned deficiencies and inadequacies.

### SUMMARY

An aspect of the present invention is to provide a touch selection system for on-screen display multiple objects, which is suitable for selecting a plurality of objects. The touch selection system includes a control interface, a control trace processing unit and a control options processing unit. The control interface is configured for controlling the objects. The control trace processing unit is configured for determining whether a control signal appears on the control interface, and recording a control moving trace formed by the control signal on the control interface. The control options processing unit is configured for calculating at least one closed area formed by the control moving trace in accordance with the control moving trace recorded in the control trace processing unit, and determining whether the objects fall within the at least one closed area so as to select the objects, and displaying at least one corresponding operation option in accordance with the selected objects.

According to one embodiment of the present invention, when an end point of the control moving trace is overlapped with a start point of the control moving trace, the control options processing unit is configured for forming the least one closed area in accordance with the control moving trace.

According to one embodiment of the present invention, when an end point of the control moving trace and an start point of the control moving trace are not overlapped, the control options processing unit is configured for connecting the start point and the end point via a straight line in accordance with the control moving trace, thereby forming the least one closed area.

According to one embodiment of the present invention, each of the objects comprises a plurality of location points including a relative upper-left point, a relative upper-right point, a relative lower-left point, a relative lower-right point and a relative central point. The control options processing unit is configured for selecting the corresponding objects in accordance with whether at least one of the location points of the objects is located within the least one closed area.

According to one embodiment of the present invention, the touch selection system further includes a memory unit. The memory unit is configured for storing coordinates of touch points corresponding to the control moving trace and coordinates of location points of the objects.

According to one embodiment of the present invention, when the selected objects are of a same file type, the control options unit is configured for displaying a corresponding control option of the same file type.

According to one embodiment of the present invention, when the selected objects are of different file types, the control options unit is configured for displaying a system common control option.

According to one embodiment of the present invention, when the objects originally in an selected status are not located within the least one closed area, the control options processing unit is configured for canceling the selected status of the objects.

Another aspect of the present invention is to provide a touch selection method for on-screen displayed multiple objects. The touch selection method is suitable for use in a control interface configured for selecting a plurality of objects. The touch selection method includes the following operations: (a) detecting whether a control signal enters on the control interface; (b) recording a control moving trace on the control interface formed by the control signal; (c) determining whether the objects are located within a dosed area formed by the control moving trace, and selecting the objects if the result is yes; and (d) displaying at least one control option in accordance with the selected objects.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram showing a touch selection system for on-screen displayed multiple objects according to one embodiment of present invention;

FIG. 2A is a schematic diagram showing a touch control operation on the control interface according to one embodiment of present invention;

FIG. 2B is a schematic diagram of the operation when the selected objects are of the same file type according to one embodiment of present invention;

FIG. 2C is a schematic diagram when the selected objects are of different file types according to another embodiment of present invention;

FIG. 2D is a schematic diagram showing another touch control operation according to the embodiment shown in FIG. 2A;

FIG. 3A is a schematic diagram showing a touch control operation according to another embodiment of the present invention;

FIG. 3B is a schematic diagram showing another touch control operation according to another embodiment of the present invention; and

FIG. 4 is a flow chart showing a touch selection method for on-screen displayed multiple objects according to one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

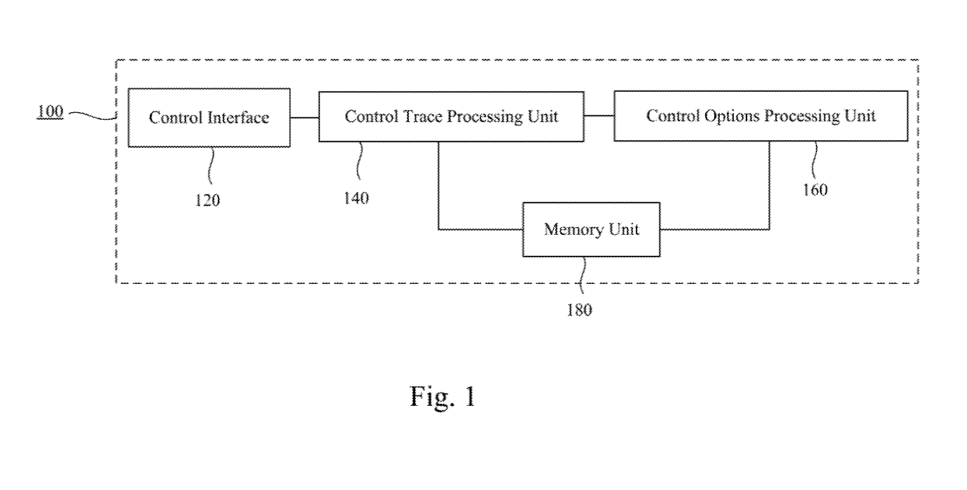

FIG. 1 is a schematic diagram showing a touch selection system 100 for on-screen displayed multiple objects according to one embodiment of present invention. The touch selection system 100 includes a control interface 120, a control trace processing unit 140, a control options processing unit 160 and a memory unit 180.

The control interface 120 is configured for allowing a user to control a plurality of objects or files. The control interface 120 may be a resistive touch panel, a capacitive touch panel or the like.

The control trace processing unit 140 is configured for detecting whether a control signal appears on the control interface 120, and recording a control moving trace formed by the control signal. In other words, whenever the user performs operations using the control interface 120, the control trace processing unit 140 detects and records the touch point (i.e., the control signal described above) generated by the user and the coordinates of its corresponding control moving trace.

The control options processing unit 160 is configured for calculating at least one closed area formed by the control moving trace in accordance with the control moving trace on the control interface 120 on which the user performed operation, and determining whether the objects are located within the least one closed area so as to select the objects. The control options processing unit 160 is further configured for displaying at least one corresponding control option in accordance with the selected objects.

Furthermore, the control trace processing unit 140 and control options processing unit 160 may be implemented as hardware, software, and/or firmware. For example, if speed and accuracy are major concerns, the aforementioned units can be implemented as hardware and/or firmware; alternatively, if flexibility is a major concern, the aforementioned units can be implemented as software; or, the aforementioned units can be implemented as a combination of hardware, software, and/or firmware. For example, the control trace processing unit 140 may be a pressure sensor and a microcontroller, and the control options processing unit 160 may be a microprocessor. The pressure sensor detects the control signal and the control moving trace on the control interface 120, and the microcontroller records and feedbacks the corresponding information to the microprocessor for selecting the objects.

The memory unit 180 is configured for storing coordinates of touch points corresponding to the control moving trace and coordinates of location points of the objects on the control interface 120. For example, the memory unit 180 may be a flash memory or a disk space shared with a system, but is not limited thereto.

The following paragraphs provide some embodiments to explain the touch selection system 100 for on-screen displayed multiple objects. For purpose of explanation, many details in practice will be described together with the following descriptions. However, it should be understood that these details in practice do not limit the disclosure.

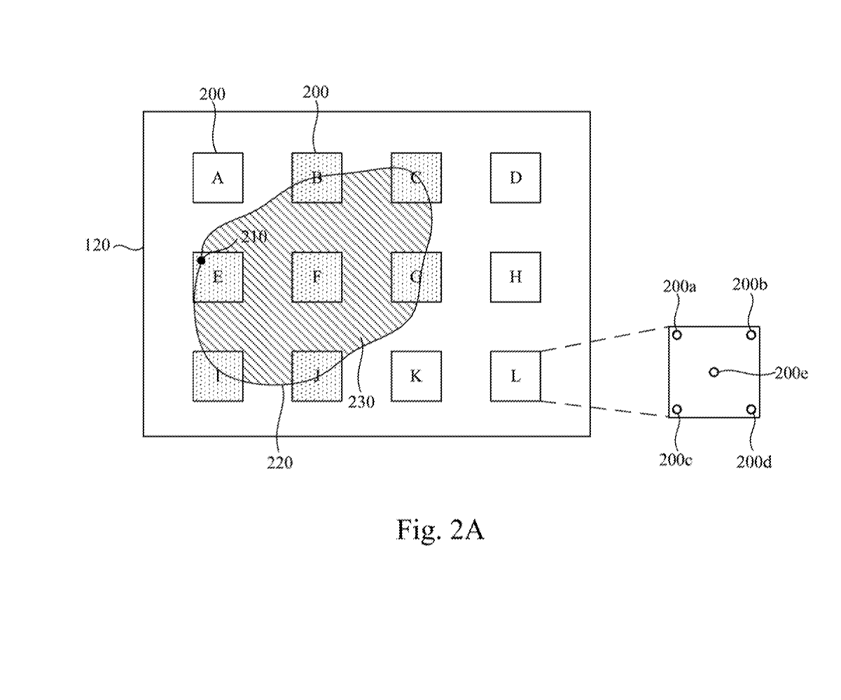

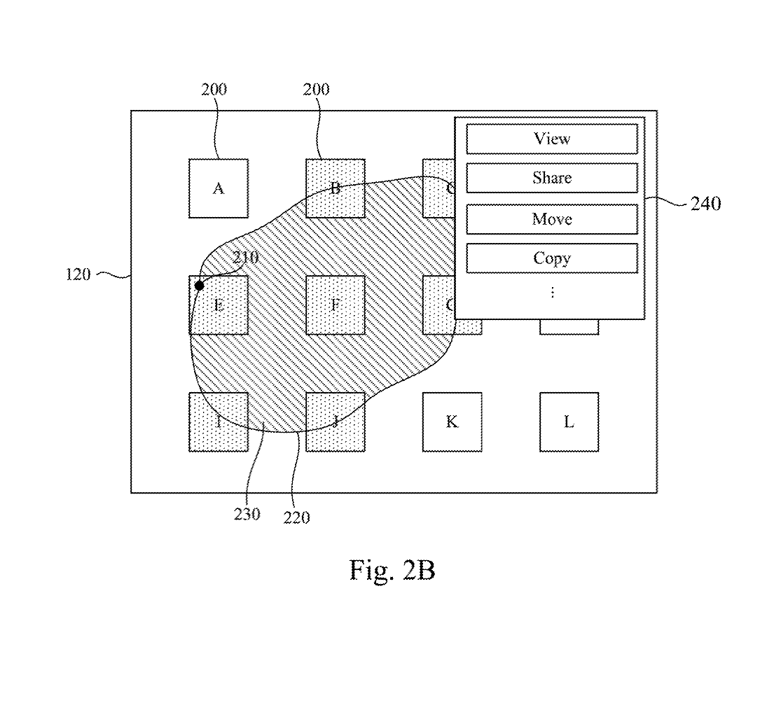

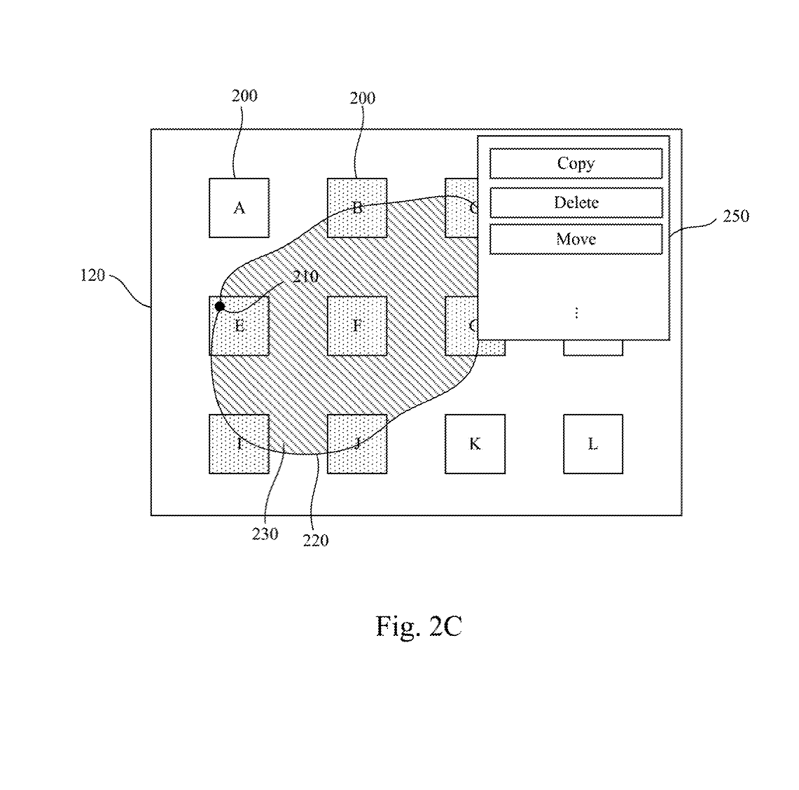

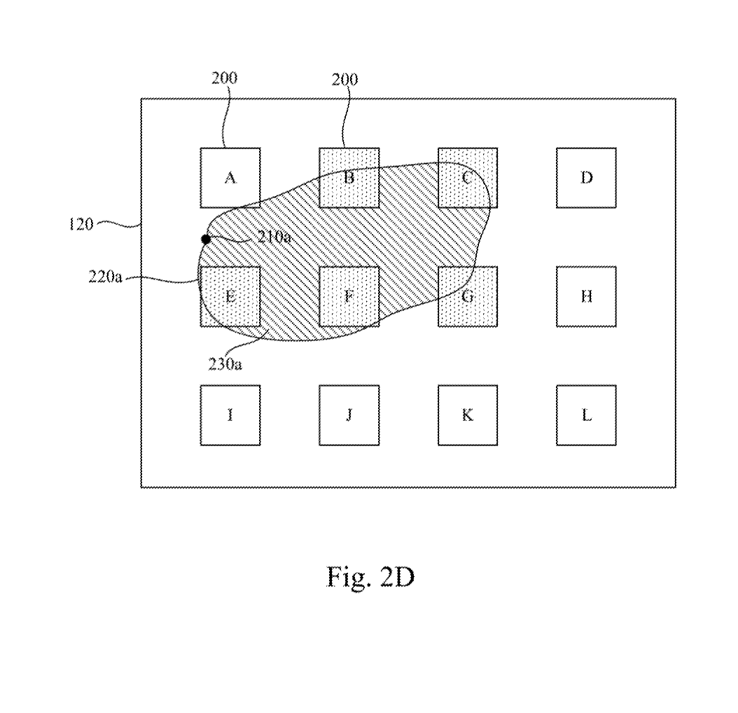

FIG. 2A is a schematic diagram showing a touch control operation on the control interface 120 according to one embodiment of present invention. As shown in FIG. 2A, objects 200 (i.e., objects A˜L) are located on the control interface 120, wherein the objects 200 are illustrated as rectangular icons in a common GUI. Each of the objects 200 includes a plurality of location points on the control interface 120. The location points may include a relative upper-left point 200a, a relative upper-right point 200b, a relative lower-left point 200c, a relative lower-right point 200d and a relative central point 200e. For better illustration, FIG. 2A only shows the location points of the object L. The coordinates of the location points of each of the objects A˜L on the control interface 120 may be stored in the memory unit 180. One of ordinary skill in the art may setup corresponding location points on the icons with different shapes, the present invention is not limited to the rectangular icon.

In this example, the user generates a touch point 210 (i.e., the aforementioned control signal) on the control interface 120, and slides from the touch point 210 to generate a control moving trace 220, and the control moving trace 220 returns to e touch point 210 so as to form a dosed area 230. The control trace processing unit 140 detects the touch point 210 and coordinates of touch points corresponding to the control moving trace 220, and then sends the information of the coordinates to the memory unit 180 for recording.

Further, in this example, an end point (i.e., the touch point 210) of the control moving trace 220 is overlapped a start point (i.e., the touch point 210) of the control moving trace 220, the control options processing unit 160 selects the objects in accordance with the closed area 230 by calculating the coordinates of the corresponding touch points of the control moving trace 220.

For example, as shown in FIG. 2A, when determines that the locations of the object B, C, E, F, G, I and J are located within the closed area 230, the control options processing unit selects the object B, C, E, F, G, I and J.

In order to determine whether the objects are located within the dosed area 230 formed by the control moving trace 220, the control options processing unit 160 may compares the location points 200a˜200e of the objects with the corresponding touch points of the closed area 230. When at least one location points 200a˜200e of the objects is located within the dosed area 230, the control options processing unit 160 selects the corresponding objects.

Moreover, the width of the control moving trace may be wider if the user performs the operation by her or his finger, which may cause an error of selecting the objects. In this case, the control options processing unit 160 can be further configured for selecting the corresponding object when at least two of the location points 200a˜200e are located in the closed area 230. The precision of selecting objects can be improved with the configuration of more location points.

FIG. 2B is a schematic diagram showing when the selected objects are a same file type according to one embodiment of present invention. FIG. 2C is a schematic diagram showing of the operation when the selected objects are different file types according to another embodiment of present invention.

After the object B, C, E, F, G, I and J are selected, the control options processing unit 160 may identify the file types of the selected objects and display the corresponding control options in accordance with the file types.

In one embodiment, if objects B, C, E, F, G, I and J are of a same file type, the control options processing unit 160 may display the corresponding control options of the same file type. For example, as shown in FIG. 2B, when the objects B, C, E, F, G, I and J are image files, the control options processing unit 160 displays the corresponding control options for the image files. In this example, the control options 240 may include any operations for the image files, such as “View”, “Share”, “Move”, “Copy”, “Zoom”, “Delete”, and so on, but not limited thereto. Hence, the user may perform the operation on the selected objects more efficiently.

In another embodiment, if object B, C, E, F, G, I and J are of different file types, the control options processing unit 160 may display a system common control option. For example, as shown in FIG. 2C, when the objects B, C, E, F, G, I and J are different file types, such as the case of the object B, C and E are image files, the object F, G and I are document files and the object J is an audio file, the control options processing unit 160 displays the system common control options both can be performed for image files, document files and audio files. In this example, the system common control option may include the operations for the aforementioned file types, such as “Copy”, “Delete”, “Move”, and so on. Further, FIG. 2B and FIG. 2C are shown for illustration purpose only, the location of control options in FIG. 2B and FIG. 2C can be adjust by a system designer in accordance with practical applications.

FIG. 2D is schematic diagram showing another touch control operation according to the embodiment of shown in FIG. 2A. After the user has performed the first operation, objects B, C, E, F, G and I are selected, as shown in FIG. 2A. As shown in FIG. 2D, the user performs another operation to generate another touch point 210a, another control moving trace 220a and a corresponding closed area 230a.

In this example, the objects B, C, E, F and G selected at the first operation are located within the new closed area 230a, and the objects I and J selected at the first operation are not located within the new closed area 230a, and thus the control options processing unit 160 keeps the objects B, C, E, F and G as being selected, and cancels the selected status of the objects I and J. In this manner, the user may generate a new control moving trace to cancel the selected status of the objects in each operation

In the embodiments described above, the control options processing unit 160 selects objects in accordance with the dosed area formed by the control moving trace, wherein the start point and the end point of the control moving trace are overlapped, but the present invention is not limited thereto.

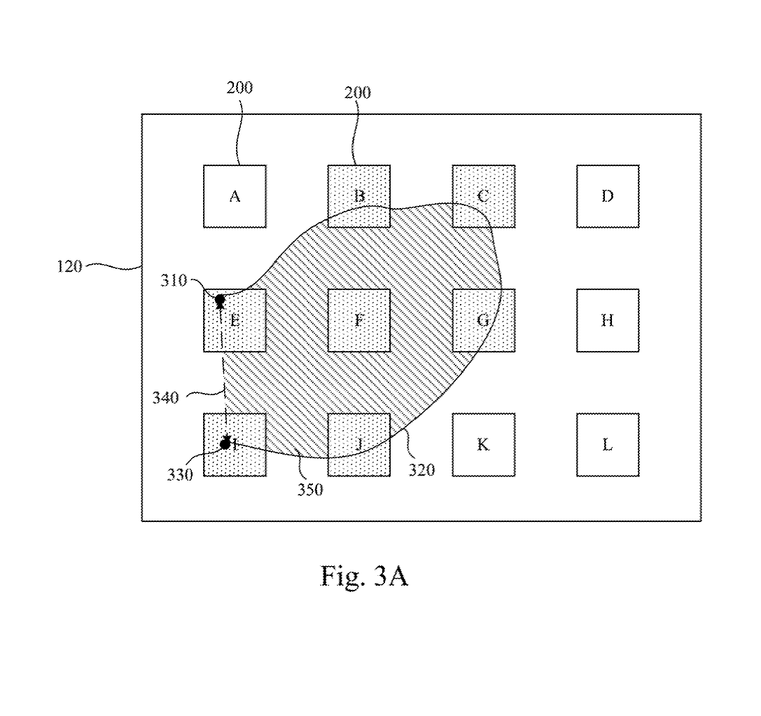

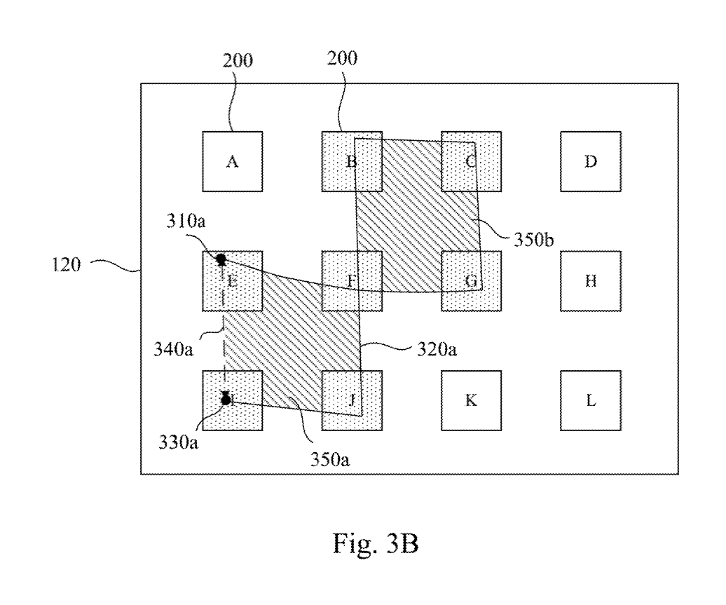

FIG. 3A is a schematic diagram showing a touch control operation according to another embodiment of the present invention. In this embodiment, the user generates a touch point 310 (i.e., the control signal) on the control interface 120 and slides from the touch point 310 to generate a control moving trace 320, and a start point (i.e., the touch point 310) and an end point (i.e., the touch point 330) of the control moving trace 320 are not overlapped. In this case, the control options processing unit 160 is configured for connecting the touch point 310 and the touch point 330 via a straight line (i.e., the connected path 340) by calculating the coordinates of the touch point 310 and the touch point 330. Then, the control options processing unit 160 generates a closed area 350 in accordance with the control moving trace 320 and the connected path 340. The control option processing unit selects the objects B, C, E, F, G, I and J in accordance with the closed area 350.

In this embodiment, the user may select the objects without needing a precise, complete and closed control moving trace, thus making the operation much easier for the user.

FIG. 3B is a schematic diagram showing another touch control operation according to another embodiment of the present invention. In this embodiment, the user generates a touch point 310a (i.e., the control signal) on the control interface 120 and slides from the touch point 310a to generate a control moving trace 320a, and a start point (i.e., the touch point 310a) and an end point (i.e., a touch point 330a) of the control moving trace 320 are not overlapped. It should be noted that a portion of the control moving trace 320a forms a closed area 350b.

Further, because the start point and the end point of the control moving trace 320a are not overlapped, the control options processing unit 160 connects the touch point 310a and the touch point 330a via a straight line (i.e., a connected path 340a) by calculating the coordinates of the touch point 310a and the touch point 330a. Then, the control options processing unit 160 generates another closed area 350a in accordance with the control moving trace 320a and the connected path 340a.

In this embodiment, the control options processing unit 160 selects the objects located within the closed area 350a and the objects located within the closed area 350b, such as the object B, C, E, F, G, I and J. In summary, the control options processing unit 160 may select objects according to any closed area generated from the operation of the user. In this manner, the user may utilize a continuous control moving trace to select two groups objects located in the both sides of the control interface 120 or numerous objects located in different locations of the control interface 120, thereby preventing the user from selecting the objects located between the target objects by mistake.

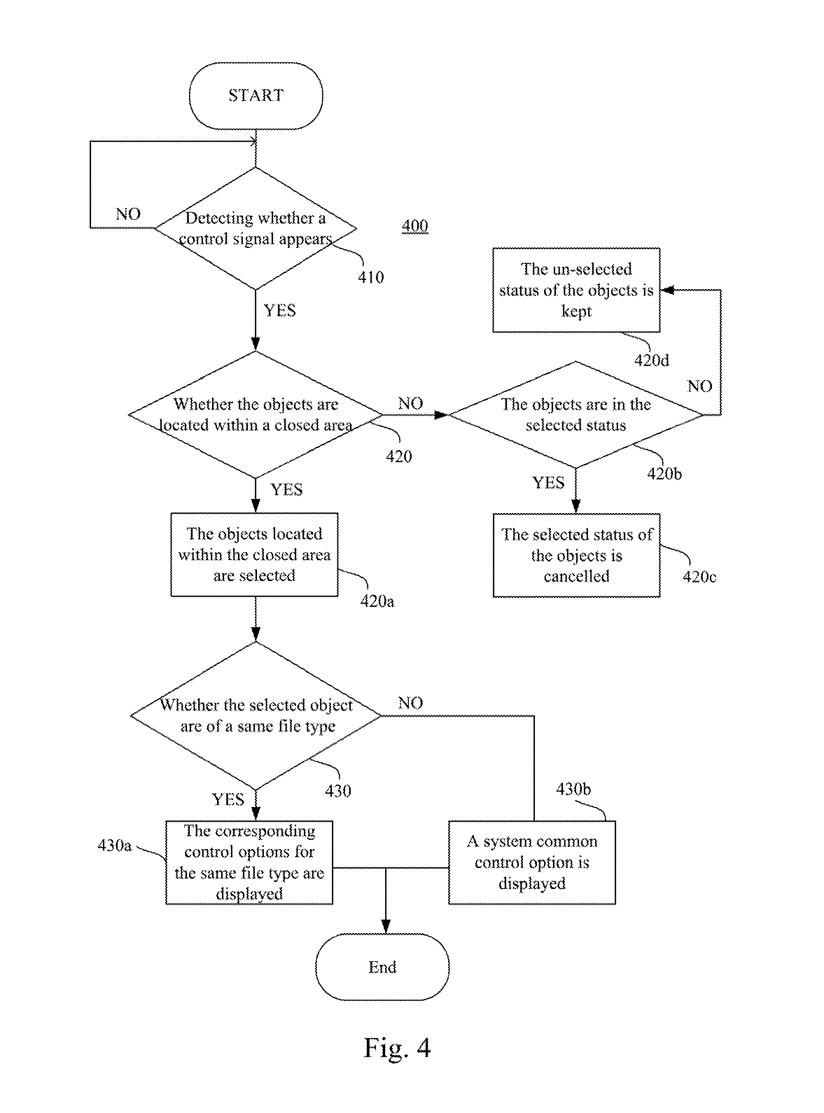

Another aspect of the present invention provides a touch selection method for on-screen displayed multiple objects t. FIG. 4 is a flow chart showing a touch selection method for on-screen displayed multiple objects according to one embodiment of the present invention.

The touch selection method 400 is suitable for use in a control interface which is configured for selecting a plurality of objects. Step 410 is preformed to detect whether a control signal appears on the control interface. If it is detected that the control signal appears on the control interface, step 420 is performed.

Step 420 is performed to record the detected control signal and a control moving trace on the control interface formed by the detected control signal, and to determine whether the objects are located within a closed area formed by the control moving trace. If the result is yes, the objects located within the closed area are selected (step 420).

For example, as shown in FIG. 2A, the touch point 210 appears on the control interface, the end point (i.e., the touch point 210) of the control moving trace 220 is overlapped with the start point (i.e., the touch point 210) of the control moving trace 220, such that the closed area 230 is formed by the control moving trace 220, and the objects B, C, E, F, G, I and J are selected.

On the other hand, in step 420, if the end point and the start point of the control moving trace are not overlapped the end point and the start point of the control moving trace can be further connected via a straight line to generate at least one closed area. For example, as shown in FIG. 3A, the start point (i.e., the touch point 310) and the end point (i.e., the touch point 330) of the control moving trace 320 are not overlapped, the start point (i.e., the touch point 310) and the end point (i.e., the touch point 330) of the control moving trace 320 can be connected via a straight line (i.e., a connected path 340), such that a closed area 350 is formed by the control moving trace 350 and the connected path 340, and the objects B, C, E, F, G, I and J are selected.

Step 430 is performed to display at least one corresponding control option in accordance with the selected objects. For example, in step 430a, if the selected objects are of a same file type, the corresponding control options for the same file type are displayed. As shown in FIG. 2B, the selected object B, C, E, F, G, I and J are image files, the control options 240 for the image files are displayed, such as “View”, “Share”, “Move”, “Copy”, and so on.

Or, in step 430b, if the selected objects are of different file types, a system common control option is displayed. For example, as shown in FIG. 2C, the selected object B, C, E, F, G, I and J are of different file types, the system common control option 250 for the different file types is displayed, such as “Copy”, “Delete”, “Move”, and so on.

Furthermore, in step 420b, if the originally selected objects are not located within the closed area formed by the control moving trace and the control signal generated by a next operation, the selected status of the objects will be cancelled (step 420c). Alternatively, if the objects are not in the selected status and are not located within the closed area generated by next operation, the un-selected status of the objects is kept (step 420d).

Further, in order to improve the precision of selecting objects, each of the objects on the control interface may have a plurality of location points. Using the object L shown in FIG. 2A as an example, the location points may include a relative upper-left point 200a, a relative upper-right point 200b, a relative lower-left point 200c, a relative lower-right point 200d and a relative central point 200e. Step 420 is performed to further determine whether a specific number of location points of each object are located within the closed area for selecting the objects.

For example, the object L includes the relative upper-left point 200a, the relative upper-right point 200b, the relative lower-left point 200c, the relative lower-right point 200d and the relative central point 200e. To improve the precision of selecting objects, the objects can be configured to be selected if three or more location points of each of the objects are located within the closed area. Alternatively. If there are only two or less location points of each of the objects are located within the closed area, the objects are not selected. In practical applications, the location points of each object 200 are not limited to the location points described above, and the selected configuration is not limited to the configuration of three location points, one of ordinary skill in the art can adjust them in accordance with practical applications.

In summary, the user can select the objects located at different locations more conveniently by using the touch selection system and the touch selection system method of the present invention, and can perform subsequent operations more efficiently after selecting the objects.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A touch selection system, suitable for selecting a plurality of on-screen displayed objects, the touch selection system comprising:
a control interface configured for controlling the objects;
a control trace processing unit configured for determining whether a control signal appears on the control interface, and recording a control moving trace formed by the control signal on the control interface; and
a control options processing unit configured for calculating at least one closed area formed by the control moving trace in accordance with the control moving trace, wherein the control options processing unit is further configured for determining whether the objects are located within the least one closed area to select the objects, and displaying at least one corresponding control option in accordance with the selected objects.

2. The touch selection system of claim 1, wherein when an end point of the control moving trace is overlapped with a start point of the control moving trace, the control options processing unit is configured for forming the least one closed area in accordance with the control moving trace.

3. The touch selection system of claim 1, wherein when an end point of the control moving trace and an start point of the control moving trace are not overlapped, the control options processing unit is configured for connecting the start point and the end point via a straight line in accordance with the control moving trace, thereby forming the least one closed area.

4. The touch selection system of claim 1, wherein each of the objects comprises a plurality of location points comprising a relative upper-left point, a relative upper-right point, a relative lower-left point, a relative lower-right point and a relative central point,
wherein the control options processing unit is configured for selecting the corresponding objects in accordance with whether at least one of the location points of the objects is located within the least one closed area.

5. The touch selection system of claim 4, further comprising a memory unit configured for storing coordinates of touch points corresponding to the control moving trace and coordinates of location points of the objects.

6. The touch selection system of claim 1, wherein when the selected objects are of a same file type, the control options unit is configured for displaying a corresponding control option of the same file type.

7. The touch selection system of claim 1, wherein when the selected objects are of different file types, the control options unit is configured for displaying a system common control option.

8. The touch selection system of claim 1, wherein when the objects originally in a selected status are not located within the least one closed area, the control options processing unit is configured for cancelling the selected status of the objects.

9. A touch selection method for on-screen displayed multiple objects, suitable for use in a control interface, wherein the control interface is configured for selecting a plurality of objects, the touch selection method comprising:
detecting whether a control signal appears on the control interface;
recording a control moving trace on the control interface formed by the control signal;
determining whether the objects are located within a closed area formed by the control moving trace, and selecting the objects if the objects are located within the dosed area; and
displaying at least one control option in accordance with the selected objects.

10. The touch selection method of the claim 9, further comprising:
connecting a start point and a end point of the control moving trace via a straight line, thereby forming the least one dosed area.

11. The touch selection method of the claim 9, wherein each of the objects comprises a plurality of location points on the control interface, wherein the location points comprises a relative upper-left point, a relative upper-right point, a relative lower-left point, a relative lower-right point and a relative central point,
wherein the location points of the objects are configured for determining whether at least one of the location points of the objects is located within the least one closed area, thereby selecting the corresponding objects.

12. The touch selection method of the claim 9, wherein when the selected objects are of a same file type, the control options unit is configured for displaying the corresponding control option of the same file type.

13. The touch selection method of the claim 9, wherein when the selected objects are of different file types, the control options unit is configured for displaying a system common control option.

14. The touch selection method of the claim 9, wherein when the objects originally in a selected status are not located within the least one closed area, the selected status of the objects are cancelled.
